(19) United States
(12) Patent Application Publication
(10) Pub. No.: US 2008/0014412 A1
(43) Pub. Date: Jan. 17, 2008

(54) Two-component composite handle for a hand tool

(75) Inventors: Johann Hortnagl, Fulpmes (AT); Gerhard Pliessnig, Fulpmes (AT)

Correspondence Address: LERNER GREENBERG STEMER LLP, P O BOX 2480, HOLLYWOOD, FL, 33022-2480, US

(73) Assignee: Ing. Johann Hortnagl - Werkzeuge Ges, mbH

(21) Appl. No.: 11/487,111

(22) Filed: Jul. 14, 2006

(51) Int. Cl. B32B 3/00

(52) U.S. Cl. 428/172

(57) ABSTRACT

A composite handle for a tool has a hard plastic material core and a softer grip cover with a natural component such as cork, cotton, flax, wood, or the like in a matrix of synthetic material. The two components are sequentially injection molded and a portion of the handle surface is formed by the soft grip cover and the remainder of the exterior surface is formed by the hard core. After the first injection shot, in which the hard plastic core is formed, the core is placed in a second mold and the temperature of the core is held at 55°-70° C. when the second shot is injected. The second component material with the natural component intimately distributed in the matrix of synthetic material may be injected at a temperature of up to approx. 220° C. and its final hardness is set by selectively mixing and adjusting the relative quantities of the natural component and the synthetic material.

### BACKGROUND OF THE INVENTION

1. Field of the Invention

The invention relates to tool handles. More specifically, the invention pertains to multi-component handles for hand tools.

2. Description of the Related Art

In a series of commonly assigned, earlier design patents, a two-component handle for bricklayer tools was disclosed. The handles shown in U.S. Design Pat. No. Des. 397,021 and U.S. Pat. No. D442,446 S are particularly suited for brick trowels, gauging trowels, or pointing trowels. The handles are formed of two plastic components, namely, a hard material forming the skeleton or core providing the required structural rigidity, and a softer material. The softer material is strategically placed to provide a “soft” grip for the user.

The hard material and the soft upper material are fully synthetic materials. While the soft grip material provides a certain amount of comfort to the user, the purely synthetic material of the grip does not provide for sufficient absorption of liquids (e.g., perspiration) and typically becomes very slippery. Blister formation upon prolonged use may also be observed. Furthermore, the materials are typically not biodegradable, they may contain plasticizers and heavy metals, and their processing often requires ozone-forming materials.

Cork grip covers have been known in a variety of applications. Most notably, grips for fishing poles have for some time been covered with cork. There, a layer of cork is glued to the structural base of the pole handle. The cork layer is not structurally sturdy, a portions of the grip typically break and peel off after only a limited amount of use.

German utility model DE 20 2005 011 634 U1 (Gebrauchsmuster), which represents a parallel development to the novel handles according to the invention, integrates cork particles in the upper grip material of a screw driver. The cork particles have a mean particle size of at least 0.2 mm and no more than 2.5 mm and they are integrated in a plastic matrix. The plastic matrix is formed of a thermoplastic elastomeric material (TPE).

### SUMMARY OF THE INVENTION

It is accordingly an object of the invention to provide a two-component composite handle for a hand tool which overcomes the above-mentioned disadvantages of the heretofore-known devices and methods of this general type and which is further improved in terms of the “touch and feel” of the handle, the tendency to cause blisters upon prolonged use, the ability to maintain its superior gripping characteristics throughout an extended session of use, which utilizes renewable and biodegradable materials to a great extent, and the manufacture of which is characterized with a view to environmentally friendly processes substantially without heavy metals and without ozone-forming gas emissions.

With the foregoing and other objects in view there is provided, in accordance with the invention, a method of manufacturing a composite handle for a tool, the method which comprises:

preparing a melt of a first component material and injecting the melt into a first mold to form therein a hard material core of the handle and defining portions of an exterior surface of the handle;

transferring the hard material core into a second mold and setting a temperature of the hard material core to between 55° and 70° C. just prior to a following second injection step;

preparing a second component material with a natural component intimately distributed in a matrix of synthetic material, and adjusting a final hardness of the second component material by selectively mixing relative quantities of the natural component and the synthetic material; and

injecting a melt of the second component material into the second mold to form therein a final form handle for the tool, with the hard material core of the handle exposed in portions of the exterior surface and the relatively soft natural component material forming remaining portions of the exterior surface.

In accordance with an added feature of the invention, the natural component is cork, cotton, wood, bark, leather, or flax. More specifically, the natural component may be provided as follows: cork in grain form with a mean diameter of 4-7 mm, cotton in rod form with a maximum length of 10 mm, leather in grain or flake form of 3-5 mm diameter, and flax in rod form having a length of substantially 10 mm and a diameter of 2-3 mm.

In accordance with an additional feature of the invention, the natural component is dried with a dew point set to substantially −35° prior to injecting into the second mold.

In accordance with another feature of the invention, the injection pressure in the first mold is set to approximately 100 bar and in the second mold to substantially 80 bar. The second component material may be injected at a temperature above 200° C., and preferably at approximately 220° C.

With the above and other objects in view there is further provided, in accordance with the invention, a composite handle for a tool, comprising:

a relatively hard material core formed of a first component material;

a relatively soft grip cover formed of a second component material partly covering the hard material core, with portions of an exterior surface of the handle defined by the hard material core and remaining portions of the exterior surface defined by the soft grip cover; and

the second component material consisting of a natural material embedded in a matrix of a synthetic material.

In accordance with again an added feature of the invention, the synthetic material is selected from the group consisting of elastomeric and thermoplastic materials. Preferably, the synthetic material is selected from the group consisting of styrene ethylbutylene styrene (SEBS), styrene-butadiene-styrene (sBS), thermoplastic (poly)olefin (TPO), ethylene vinyl acetate (EVA), polypropylene (PP), polyethylene (PE), PS, TPK, plasticizers, and stabilizers.

In accordance with a concomitant feature of the invention, the first component material is polypropylene. Alternatively, the material may be polyethylene (PE), ethylene vinyl acetate (EVA), acrylonitrile butadiene styrene (ABS), styrene acrylonitrile (SAN), TPK, polystyrene (PS), acrylonitrile-styrene-acrylate terpolymer (ASA), and/or phenylene ether co-polymer (PPE).

Other features which are considered as characteristic for the invention are set forth in the appended claims.

Although the invention is illustrated and described herein as embodied in a composite handle for a hand tool, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is a perspective view of an exemplary embodiment of the composite material handle according to the invention;

FIG. 2 is a longitudinal section taken through the handle of FIG. 1;

FIG. 3 is a flowchart illustrating an exemplary process sequence for molding the handle according to the invention;

FIG. 4 is a side elevational view illustrating a pair of pliers with a handle according to the invention;

FIG. 5A is a perspective view of an exemplary handle for a woodworking tool;

FIG. 5B is a line drawing of the same handle, on a slightly reduced scale;

FIG. 6 is a side view of a hammer handle according to the invention;

FIG. 7 is a similar view of a hatchet with a handle according to the invention;

FIG. 8 is a side view of a hacksaw with a handle and an cover on the front bracket;

FIG. 9A is a perspective view of an exemplary screwdriver; and

FIG. 9B is a line drawing of the handle of the screwdriver illustrated in FIG. 9A.

### DESCRIPTION OF THE PREFERRED EMBODIMENTS

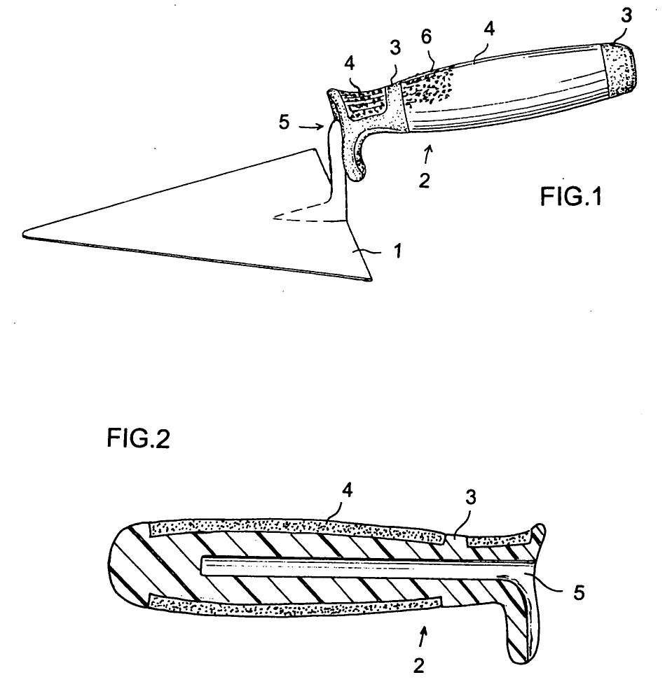

Referring now to the figures of the drawing in detail and first, particularly, to FIG. 1 thereof, there is seen a brick trowel 1 with a handle 2 according to the invention. The handle 2 is formed of two-component composite material, with a hard skeleton or core 3 and a soft grip cover 4. The core 3 is primarily responsible for the structural rigidity of the handle. The grip cover 4 is designed to provide for the superior gripping characteristics of the handle.

The core 3 may be formed of any material that is suitably moldable and also provides for the proper rigidity. Preferred materials are saturated or unsaturated poly-propylene. Other materials are polyethylene (PE), ethylene vinyl acetate (EVA), acrylonitrile butadiene styrene (ABS), styrene acrylonitrile (SAN), TPK, polystyrene (PS), acrylonitrile-styrene-acrylate terpolymer (ASA), or co-polymers such as PPE (phenylene ether co-polymer), to name a few. In the preferred implementation, the materials should be suitable in particular for injection molding. The handle 2 is formed with a core opening 5, in which an attachment stem of the trowel 1 is inserted.

The soft grip cover 4 is intimately integrated in the handle 2. That is, the transition boundaries between the visible exterior surfaces of the core 3 and of the grip cover 4 are quite smooth. Any leftover flashings from the molding process (first and second shot) are carefully avoided and removed. The grip cover 4 contains biological material from a renewable resource. In a preferred embodiment, the natural material is wood, bark, cork, cotton, flax, and/or leather. Particles 6 or strands of the natural material are integrated in a matrix of synthetic material. The hardness of the synthetic, or plastic, material matrix, and thus of the grip cover, may be adjusted depending on the intended use and designed withstand strength of the handle. The plastic material matrix may include any elastomeric and thermoplastic materials such as, for example, styrene ethylbutylene styrene (SEBS), styrene-butadiene-styrene (sBS), thermoplastic (poly)olefin (TPO), ethylene vinyl acetate (EVA), polypropylene (PP), polyethylene (PE), PS, TPK, plasticizers, and stabilizers.

The natural component is embedded in the matrix of the synthetic material. Cork is integrated as grains having a mean diameter of 4-7 mm. Cotton would typically be provided in rods with a maximum length of 10 mm. Leather is best provided in grains or leather flakes of 3-5 mm diameter. Flax would be provided in rods having a length of approx. 10 mm and a diameter of 2-3 mm.

The hardness and the relative malleability of the grip cover are adjusted by a suitable addition of plasticizers and by selecting polymers of specific hardness. These selections depend on the intended use of the handle. A hammer or hatchet handle, for example, may be configured with a Shore A hardness of approximately 70 to 80, while a chisel handle or a trowel handle may be configured with a softer grip of, say, Shore A hardness of approximately 45-60. Similarly, the “feel” of the grip during an extended working session must be assured to remain pleasing to the hand of the user. The relative slip or non-slip characteristics of the grip may also be adjusted by a proper selection of the material composition.

In addition, a high degree of UV resistance has been achieved, as well as an advantageous soiling behavior and easy washability. Finally, we have been able to avoid using a number of toxicologically and environmentally questionable additives, such as plasticizers, accelerators, cadmium, heavy metals, color additives, and the like. The resulting handle (bio handle) can thus be recycled.

The intimate connection between the core and the grip cover lies at the heart of this invention. In tool, in particular, where extended use and a demanding work environment places considerable stress on the materials, it is paramount for a good tool that the integrity of the handle remain properly intact. We refer to the connection as a 100% connection in this context, where the boundary or transitional layer material is as structurally resistant as the substrate and/or as the grip cover material itself. We have found that our finely tuned molding process leads to just such a 100% connection.

We use a fully automatic process in manufacturing the novel handles. The processing of the hard component (i.e., the core) following the first shot injection is timed with a relatively tight cycle time, so that it retains a carefully adjusted elevated temperature. This temperature then assures that the softer material (i.e., the grip cover) applied in the second shot injection is properly bound to hard component and that the result is the above-noted 100% connection between the components.

It is further important to intimately integrate the natural component within the plastic matrix of the synthetic grip cover material. The natural component mixtures are produced in a heavy-duty compounder. The natural components are also carefully selected so as to allow for a processing temperature of approximately 200° C. or even 220° (without charring of the natural component), which has been found to be ideal for the proper connection of the grip cover material to the hard component of the core.

The mixture for the grip cover material is prepared in a high-energy mixing system, in which the natural component and the synthetic component are formed into a mass of granules.

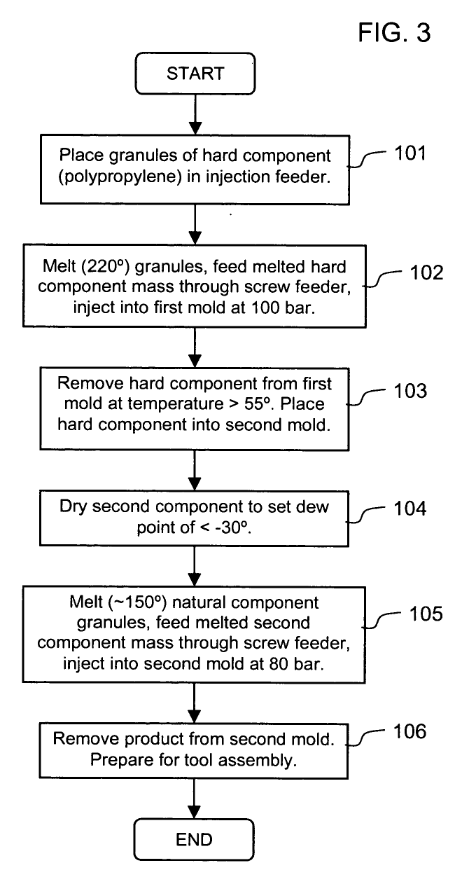

The process according to the invention may be best understood with reference to a specific embodiment of the molding process. Here, we form a handle for a bricklayer trowel with a cork grip. Reference is had to FIG. 3 and the numbered steps illustrated therein:

The hard component is polypropylene (PP). It may or may not contain a filler (e.g., glass fibers, carbon fibers, etc.—for improving the working characteristics and the rigidity). The polypropylene component is obtained in granule form with a mean particle diameter of approx. 3 mm. First, the granules are added into a hopper of an injection molding machine at step 101. At this time, any type of pigment or other coloring agent may be added to adjust the color of the handle core. Then the granules are melted at 220° and delivered via a screw feeder and injected into a first mold, at step 102. The injection pressure is approximately 100 bar.

In step 103, the polypropylene component is subsequently removed from the first mold and delivered for the second injection shot. The transfer from the first mold to the second mold may either be effected by index or rotary table process, or the component may be completely removed and delivered for the second injection shot. Either way, the second mold contains additional cavities as compared to the first mold, for the natural component, here the cork grip cover. First, the component is either cooled down to 55°-70° C. (index table) or reheated to that temperature.

The second component, i.e. the natural component is also provided in granule form. The cork mass, as here, is provided as grains having a mean diameter of 4-7 mm. Such cork granules are commercially available. By way of example, a suitable material is “Kork UV 75410-7-D beige A104” of Wind Thermoplast-handel of Traiskirchen, Austria. The grains of the natural component are dried in a dry air dryer with a dew point set to −35° C. at step 104. This removes any residual moisture and prepares the cork component for the molding process. Then the grain bulk is delivered to the injection machine, where it is heated in the material hopper to about 130°-1750. The heated material is then delivered through a screw feeder with a one way check valve for injection into the second mold at step 105. There, the polypropylene handle core is already present with a temperature of 55°-70° C. The injection is carefully timed with a proper injection profile and with an injection pressure of approx. 80 bar. The mold temperature is set to between 40° and 60° C. The mold surfaces of the second mold are provided with a suitable non-stick coating, such as a PTFE (polytetrafluoroethylene, Teflon®) coating.

The selection of the materials, which are chemically compatible, and the temperature characteristics during the molding process cause the first component to be melted at the boundary surfaces and the second component to be fused into the first component. This leads to the above-defined 100% connection between the components.

Then the finished two-component handle is removed from the second mold at step 106. After any flashings that may be present are removed, the handle is ready for delivery and for assembly on the tool. It should be understood, however, that the handle may also be molded directly onto the tool.

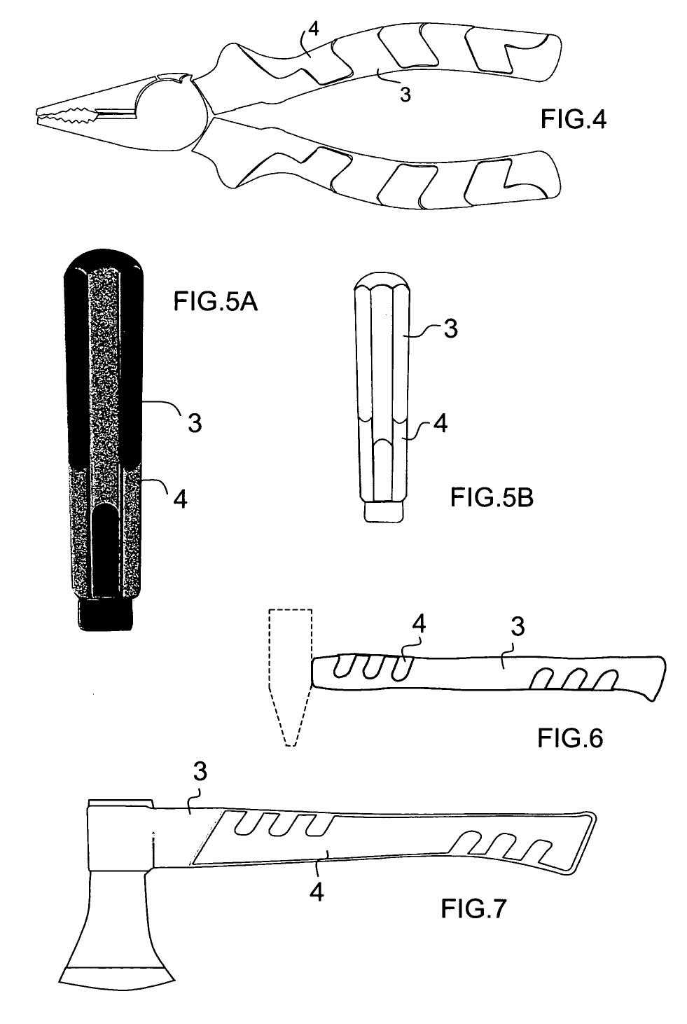

One example of such a directly molded handle set is illustrated in FIG. 4. There, the hard component and the soft component are directly injection-molded onto the underlying handle substrates. The ensures intimate contact and a durable connection with the underlying pliers. The connection and fusing between the hard component and the soft component is ensured as outlined above.

FIGS. 5A and 5B illustrate a handle for a wood-carving tool. Here, the butt of the tool is formed of the hard component, so as to assure that the tool may withstand even hammer impact, which may, under certain circumstances, be necessary. FIGS. 5A and 5B further illustrate how flexible the novel designs are in terms of the ornamental aspects of the handles.

FIGS. 6 and 7 illustrate a hammer and a hatchet, respectively. There; the tool, i.e., the metallic substrate of the tool, is subjected to directly injection. The first and second molds are formed to receive the tool and the injection is strategically placed as defined by the mold cavities.

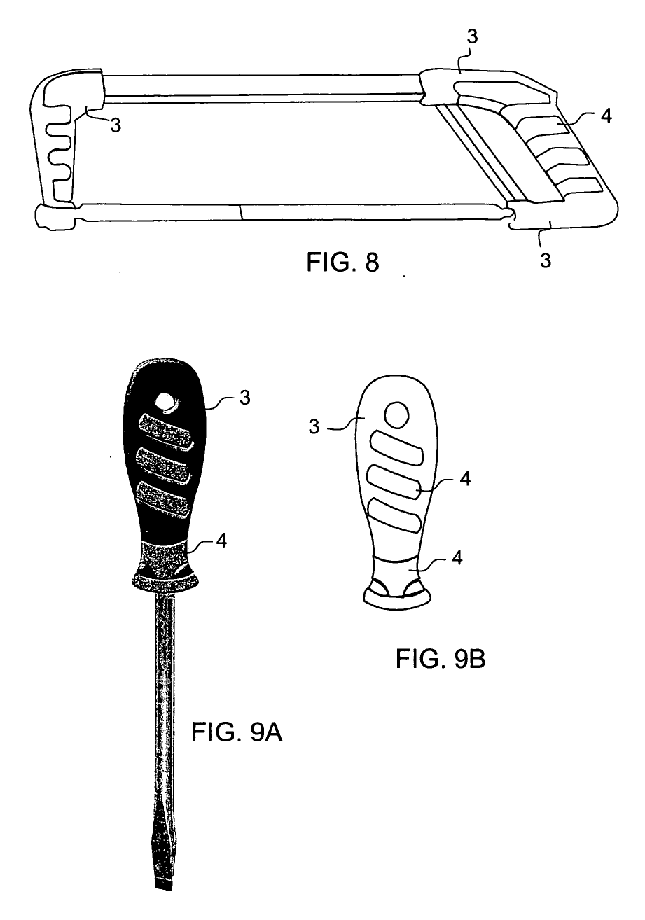

FIG. 8 also pertains to a directly molded tool handle. In addition, the forward end of the hacksaw, which is not usually used as a tool, is molded with a matching design. In some cases, of course, the saw may be gripped at the forward end as well.

FIGS. 9A and 9B, finally, show a screw driver assembly with a novel handle. Here, too, the screw driver stem is directly integrated into the handle. In other words, the first shot injection is effected directly onto the core of the screw driver. One advantage obtained by such direct injection is that it is not absolutely necessary to use an ejector pin for removing the product from the molds. Instead, the product may be handled by the non-molded, exposed metal parts.

This application claims the benefit, under 35 U.S.C. §§ 119 and 172, of European Community (OHIM—Office for the Harmonization of the Internal Market) design application No. 000509815 of Apr. 7, 2006, and of Austrian design patent application MU 629-635/2006 of May 26, 2006; the prior applications are herewith incorporated by reference in their entirety.

We claim:

1. A method of manufacturing a composite handle for a tool, the method which comprises:
preparing a melt of a first component material and injecting the melt into a first mold to form therein a hard material core of the handle and defining portions of an exterior surface of the handle;
transferring the hard material core into a second mold and setting a temperature of the hard material core to between 55° and 70° C. just prior to a following second injection step;
preparing a second component material with a natural component intimately distributed in a matrix of synthetic material, and adjusting a final hardness of the second component material by selectively mixing relative quantities of the natural component and the synthetic material; and
injecting a melt of the second component material into the second mold to form therein a final form handle for the tool, with the hard material core of the handle exposed in portions of the exterior surface and the relatively soft natural component material forming remaining portions of the exterior surface.

2. The method according to claim 1, which comprises selecting the natural component from the group consisting of cork, cotton, wood, bark, leather, and flax.

3. The method according to claim 1, which comprises selecting the natural component from the group consisting of cork in grain form with a mean diameter of 4-7 mm, cotton in rod form with a maximum length of 10 mm, leather in grain or flake form of 3-5 mm diameter, and flax in rod form having a length of substantially 10 mm and a diameter of 2-3 mm.

4. The method according to claim 1, which comprises drying the natural component with a dew point set to substantially −35° prior to injecting into the second mold.

5. The method according to claim 1, which comprises setting an injection pressure in the first mold to substantially 100 bar and an injection pressure in the second mold to substantially 80 bar.

6. The method according to claim 1, which comprises injecting the second component material at a temperature above 200° C.

7. A composite handle for a tool, comprising:
a relatively hard material core formed of a first component material;
a relatively soft grip cover formed of a second component material partly covering said hard material core, with portions of an exterior surface of the handle defined by said hard material core and remaining portions of the exterior surface defined by the soft grip cover; and
said second component material consisting of a natural material embedded in a matrix of a synthetic material.

8. The composite handle according to claim 7, wherein said natural material is selected from the group consisting of cork, cotton, wood, bark, leather, and flax.

9. The composite handle according to claim 7, wherein said natural material is cork in the form of particles having a mean diameter of 0.4 to 7 mm.

10. The composite handle according to claim 7, wherein said natural material is selected from the group consisting of cork in grain form with a mean diameter of 4-7 mm, cotton in rod form with a maximum length of 10 mm, leather in grain or flake form of 3-5 mm diameter, and flax in rod form having a length of substantially 10 mm and a diameter of 2-3 mm.

11. The composite handle according to claim 7, wherein said synthetic material is selected from the group consisting of elastomeric and thermoplastic materials.

12. The composite handle according to claim 7, wherein said synthetic material is selected from the group consisting of styrene ethylbutylene styrene (SEBS), styrene-butadiene-styrene (sBS), thermoplastic (poly)olefin (TPO), ethylene vinyl acetate (EVA), polypropylene (PP), polyethylene (PE), PS, TPK, plasticizers, and stabilizers.

13. The composite handle according to claim 7, wherein said first component material is polypropylene.

14. The composite handle according to claim 7, wherein said first component material is selected from the group consisting of polyethylene (PE), ethylene vinyl acetate (EVA), acrylonitrile butadiene styrene (ABS), styrene acrylonitrile (SAN), TPK, polystyrene (PS), acrylonitrile-styrene-acrylate terpolymer (ASA), and phenylene ether co-polymer (PPE).
